(19) United States
(12) Patent Application Publication
(10) Pub. No.: US 2024/0179509 A1
(43) Pub. Date: May 30, 2024

(54) PROSE DISCOVERY WIRELESS DEVICE IDENTIFIER UPDATING

(71) Applicant: Telefonaktiebolaget LM Ericsson (publ), Stockholm (SE)

(72) Inventors: Zhang FU, Stockholm (SE); Maria Belen PANCORBO MARCOS, Madrid (ES); Juying GAN, Shanghai (CN); Fuencisla GARCIA AZORERO, Madrid (ES)

(21) Appl. No.: 18/551,274

(22) PCT Filed: Mar. 29, 2022
(86) PCT No.: PCT/IB2022/052904

§ 371 Date: Sep. 19, 2023

Related U.S. Application Data
(60) Provisional application No. 63/168,602, filed on Mar. 31, 2021.

(51) Int. Cl. H04W 8/00

(52) U.S. Cl. CPC H04W 8/005

(57) ABSTRACT

A method, system and apparatus are disclosed. A core network node is provided. The core network node includes processing circuitry configured to receive an indication, via control plane signaling, associated with the wireless device where the indication indicates whether to update a ProSe discovery identifier associated with the wireless device, one of update and refrain from updating the ProSe discovery identifier based at least on the received indication, and transmit the updated ProSe discovery identifier if the ProSe discovery identifier was updated.

### FIELD

The present disclosure relates to wireless communications, and in particular, to ProSe direct discovery control.

### BACKGROUND

### ProSe in 4G Systems

As described in Third Generation Partnership Project (3GPP) standards such as in clause 4.4.1 of 3GPP Technical Specification (TS) 23.303 V15.1.0, the ProSe (i.e., Proximity-services) Function is the logical function that is used for network related actions required for ProSe. The ProSe Function plays different roles for each of the features of ProSe. It may be assumed that there is only one logical ProSe Function in each public land mobile network (PLMN) that supports Proximity Services.

If multiple ProSe Functions are deployed within the same PLMN (e.g., for load reasons), then the method to locate the ProSe Function that has allocated a specific ProSe Application Code or ProSe Restricted Code (e.g., through a database lookup, etc.) is not defined in this version of 3GPP TS 23.303. FIG. 1 is a diagram of a wireless device (e.g., User Equipment (UE)) to ProSe function interfaces for each sub-function of 3GPP TS 23.303 Version (V) 15.1.0. FIG. 2 is a diagram of a ProSe Function interfaces to other network elements and PLMNs of 3GPP TS 23.303 V 15.10.

The ProSe Function includes three sub-functions that perform different roles depending on the ProSe feature:
Direct Provisioning Function (DPF) is used to provision the wireless device with necessary parameters in order use ProSe Direct Discovery and Prose Direct Communication. It is used to provision the wireless devices with PLMN specific parameters that allow the wireless device to use ProSe in this specific PLMN. For direct communication used for Public Safety DPF is also used to provision the wireless device with parameters that are needed when the wireless device is not served by E-UTRAN. For restricted ProSe Direct Discovery, it also generates and maintains the ProSe Discovery User Equipment (UE) Identifier (ID) (PDUID).
Direct Discovery Name Management Function is used for open Prose Direct Discovery to allocate and process the mapping of ProSe Applications IDs and ProSe Application Codes used in ProSe Direct Discovery. It uses ProSe related subscriber data stored in HSS for authorization for each discovery request. It also provides the wireless device with the necessary security material in order to protect discovery messages transmitted over the air. In restricted ProSe Direct Discovery, it also interacts with the Application Server via PC2 reference points for the authorization of the discovery requests.
EPC-level Discovery ProSe Function has a reference point towards the Application Server (PC2), towards other ProSe Functions (PC6), towards the HSS (PC4a) and the wireless device (PC3). The functionality includes the following:
   Storage of ProSe-related subscriber data and/or retrieval of ProSe-related subscriber data from the HSS;
   Authorization and configuration of the wireless device for EPC-level ProSe Discovery and EPC-assisted WLAN direct discovery and communication over PC3;
   Storage of a list of applications that are authorized to use EPC-level ProSe Discovery and EPC-assisted WLAN direct discovery and communication;
   Acting as location services client (SLP agent) to enable EPC-level ProSe Discovery;
   Providing the wireless device with information to assist WLAN direct discovery and communications;
   Handling of EPC ProSe User IDs and Application Layer User IDs;
   Exchange of signaling with 3rd party Application Servers over PC2 reference point for application registration and identifier mapping;
   Exchange of signaling with ProSe Functions in other PLMNs over PC6 reference points for sending proximity requests, proximity alerts and location reporting;
   Optional support for functionality for requesting wireless device location via the HSS.

The ProSe Function may support “on demand” announcing requested by the wireless device based on operator's policy, in case of ProSe restricted discovery model A.

The ProSe Function provides the necessary charging and security functionality for usage of ProSe (both ProSe via the EPC and for ProSe Direct Discovery, ProSe Direct Communication and WLAN direct discovery and communication).

The ProSe Function in HPLMN can be reached if Home Routed configuration is applied for packet data network (PDN) connection (e.g., PDN gateway (GW) is located in the home public land mobile network (HPLMN)), when such function is supported by the HPLMN. In case of Local Breakout (e.g., PDN GW is located in the visited public land mobile network (VPLMN)), a ProSe Proxy Function can be deployed by the VPLMN to support the wireless device to Home ProSe Function communication, if inter-PLMN signaling is required. Whether a PDN connection is provided by Local Breakout or Home Routed is determined by the HSS configuration described in 3GPP TS 23.401. The wireless device is not aware of this and as such will not know which access point name (APN) can be used for communication with ProSe Function unless specific APN information is configured in the wireless device indicating that this APN provides signaling connectivity between the wireless device and the Home ProSe Function.

### ProSe Direct UE ID (PDUID):

A temporary identifier assigned by the ProSe Function in the HPLMN to the wireless device for the restricted direct discovery service. It includes the PLMN ID and a temporary identifier that uniquely identifies the wireless device in the HPLMN.

### Restricted ProSe Application User ID (RPAUID):

An identifier associated with the Application Layer User ID in the ProSe Application Server in order to hide/protect the application level user identity from the 3GPP layer. It unambiguously identifies the wireless device within a given application. The format of this identifier is outside the scope of 3GPP.

### ProSe Application Server:

The ProSe Application Server supports the following capability:
Storage of EPC ProSe User IDs: ProSe Function IDs, ProSe Discovery UE ID, metadata;
Mapping of Application Layer User IDs and EPC ProSe User IDs;
Mapping of RPAUID and PDUID for restricted ProSe Direct Discovery;
Maintaining permission information for the restricted ProSe Direct Discovery using RPAUIDs;
Allocation of the ProSe Restricted Code Suffix pool, if restricted Direct Discovery with application-controlled extension is used;
Allocation of the mask(s) for ProSe Restricted Code Suffix, if restricted Direct Discovery with application-controlled extension is used.

### Usage of PDUID:

The ProSe enabled wireless device retrieves PDUID from the ProSe Function. The wireless device provides its PDUID to the ProSe Application Server and get its RPAUID from the server. When the ProSe enabled wireless device wants to conduct restricted ProSe discovery, it sends either the Announce request or Monitor request to its ProSe Function to get the corresponding restricted discovery code (details are described in 3GPP specification such as in, for example, clause 5.3.3 3GPP TS 23.303 v 15.1.0). In the request, the wireless device includes its UE ID (i.e., international mobile subscriber identity (IMSI)) and its restricted ProSe Application User ID (RPAUID). If the ProSe Function needs an authorization result from the Application Server, then it sends the Authorization request to the ProSe Application server with the RPAUID. The ProSe Application server response with the wireless device's PDUID to the ProSe Function if the authorization is OK. The ProSe Function checks if the PDUID is the one mapped to the UE ID (i.e., IMSI).

### PDUID Provisioning in 5G Systems

If the wireless device supports ProSe Direct Discovery and it does not have valid ProSe policy/parameters, the wireless device includes the UE Policy Container including the ProSe Policy Provisioning Request during the wireless device registration procedure, as described in 3GPP specification such as in, for example, clause 6.2.2 in 3GPP TS 23.304 v0.1.0.

The ProSe Policy Provisioning parameters includes the PDUID, that the policy control function (PCF) maintains as described in 3GPP specification such as in, for example, clause 5.1.2.1 in 3GPP TS 23.304 v0.1.0.

When the PCF maintains the PDUID, the PCF may keep updating the PDUID according to the timer and provision the new PDUID to the wireless device. However, the wireless device may not always want to perform restricted ProSe direct discovery. Therefore, it is wasting resources if PCF keeps updating PDUID but the wireless device does not use it.

### SUMMARY

Some embodiments advantageously provide methods, systems, and apparatuses for ProSe direct discovery control. Several example options are provided herein that help at least in part solve issues associated with existing systems. For example:
Option 1: the PCF keeps updating the PDUID by default. When the wireless device does not want to perform a restricted ProSe direct discovery anymore, the wireless devices may inform the Core Network of such via signaling or messaging, e.g., NAS message, then the PCF stops maintaining the PDUID for that wireless device such as for example, based at least on and/or in response to the signaling or messaging.
Option 2: the PCF does not update (e.g., refrains from updating) PDUID by default. When the wireless devices wants or determines or triggers to perform restricted ProSe direct discovery, if the current PDUID is expired, the wireless devices sends a request (e.g., signaling and/or messaging) to the Core Network, then PCF generates a new PDUID for the wireless devices such as, for example, based at least on and/or in response to the request.

One or more embodiments described herein advantageously allows for the PCF to maintain PDUIDs in an efficient manner. In particular, the PCF does not need to update PDUID for a wireless device if the wireless device does not need to perform restricted ProSe direct discovery even if the wireless device is authorized to perform restricted ProSe direct discovery. One or more embodiments described herein may reuse the existing messaging (e.g., one or more messages)/signaling in the standard as described herein to provide new functionality that has limited impact on existing standards.

According to one aspect of the present disclosure, a core network node configured to communicate with a wireless device is provided. The core network node includes processing circuitry configured to: receive an indication, via control plane signaling, associated with the wireless device where the indication indicates whether to update a ProSe discovery identifier associated with the wireless device, one of update and refrain from updating the ProSe discovery identifier based at least on the received indication, and transmit the updated ProSe discovery identifier if the ProSe discovery identifier was updated.

According to one or more embodiments of the aspect, the indication is a discovery type indication configured to cause the ProSe discovery identifier to be updated. According to one or more embodiments of the aspect, the indication is a registration request requesting to update a restricted discovery capability associated with the wireless device for disabling restricted discovery. According to one or more embodiments of the aspect, the ProSe discovery identifier is associated with a timer where the processing circuitry is configured to update the ProSe discovery identifier based on expiration of the timer.

According to one or more embodiments of the aspect, the processing circuitry is configured to update the ProSe discovery identifier based on the ProSe discovery identifier being invalid. According to one or more embodiments of the aspect, the indication indicates a change in the ProSe capabilities of the wireless device, and where the refraining from updating the ProSe discovery identifier is based on the change in the ProSe capabilities of the wireless device. According to one or more embodiments of the aspect, the indication is included in a NAS message indicating not to update the ProSe discovery identifier associated with the wireless device.

According to another aspect of the present disclosure, a method implemented by a core network node that is configured to communicate with a wireless device is provided. An indication is received via control plane signaling where the indication is associated with the wireless device where the indication indicates whether to update a ProSe discovery identifier associated with the wireless device. The ProSe discovery identifier one of is updated or refrained from being updated based at least on the received indication. The updated ProSe discovery identifier is transmitted if the ProSe discovery identifier was updated.

According to one or more embodiments of the aspect, the indication is a discovery type indication configured to cause the ProSe discovery identifier to be updated. According to one or more embodiments of the aspect, the indication is a registration request requesting to update a restricted discovery capability associated with the wireless device for disabling restricted discovery. According to one or more embodiments of the aspect, the ProSe discovery identifier is associated with a timer where the processing circuitry is configured to update the ProSe discovery identifier based on expiration of the timer.

According to one or more embodiments of the aspect, the ProSe discovery identifier is updated based on the ProSe discovery identifier being invalid. According to one or more embodiments of the aspect, the indication indicates a change in the ProSe capabilities of the wireless device where the refraining from updating the ProSe discovery identifier is based on the change in the ProSe capabilities of the wireless device. According to one or more embodiments of the aspect, the indication is included in a NAS message indicating not to update the ProSe discovery identifier associated with the wireless device.

According to another aspect of the present disclosure, a wireless device configured to communicate with a network node is provided. the wireless device includes processing circuitry configured to determine whether to update a ProSe discovery identifier associated with the wireless device, transmit, via control plane signaling, an indication associated with the wireless device based on the determination where the indication indicates whether to update the ProSe discovery identifier, and receive an updated ProSe discovery identifier if the indication indicated to update the ProSe discovery identifier.

According to one or more embodiments of the aspect, the indication is a discovery type indication configured to cause the ProSe discovery identifier to be updated. According to one or more embodiments of the aspect, the indication is a registration request requesting to update a restricted discovery capability associated with the wireless device for disabling restricted discovery. According to one or more embodiments of the aspect, the ProSe discovery identifier is associated with a timer, and where the processing circuitry is configured to receive another updated ProSe discovery identifier based on expiration of the timer.

According to one or more embodiments of the aspect, the determination whether to update a ProSe discovery identifier associated with the wireless device includes determining a current ProSe discovery identifier is invalid. According to one or more embodiments of the aspect, the indication indicates a change in the ProSe capabilities of the wireless device and indicates not to update the ProSe discovery identifier. According to one or more embodiments of the aspect, the indication is included in a NAS message indicating not to update the ProSe discovery identifier associated with the wireless device.

According to another aspect of the present disclosure, a method implemented by a wireless device that is configured to communicate with a network node is provided. A determination is performed whether to update a ProSe discovery identifier associated with the wireless device. An indication associated with the wireless device is transmitted via control plane signaling based on the determination where the indication indicates whether to update the ProSe discovery identifier. An updated ProSe discovery identifier is received if the indication indicated to update the ProSe discovery identifier.

According to one or more embodiments of the aspect, the indication is a discovery type indication configured to cause the ProSe discovery identifier to be updated. According to one or more embodiments of the aspect, the indication is a registration request requesting to update a restricted discovery capability associated with the wireless device for disabling restricted discovery. According to one or more embodiments of the aspect, the ProSe discovery identifier is associated with a timer, and another updated ProSe discovery identifier is received based on expiration of the timer.

According to one or more embodiments of the aspect, the determination whether to update a ProSe discovery identifier associated with the wireless device includes determining a current ProSe discovery identifier is invalid. According to one or more embodiments of the aspect, the indication indicates a change in the ProSe capabilities of the wireless device and indicates not to update the ProSe discovery identifier. According to one or more embodiments of the aspect, the indication is included in a NAS message indicating not to update the ProSe discovery identifier associated with the wireless device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a UE to ProSe function interfaces for each sub-function;

FIG. 2 is a diagram of ProSe function interfaces to other network elements and PLMNs;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a wireless device according to some embodiments of the present disclosure;

FIG. 10 is a flowchart of another example process in a wireless device according to some embodiments of the present disclosure;

FIG. 11 is a flowchart of an example process in a core network node according to some embodiments of the present disclosure; and

FIG. 12 is a flowchart of another example process in a core network node according to some embodiments of the present disclosure.

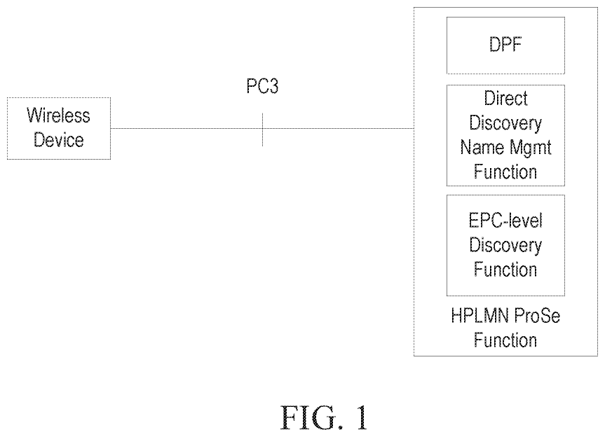

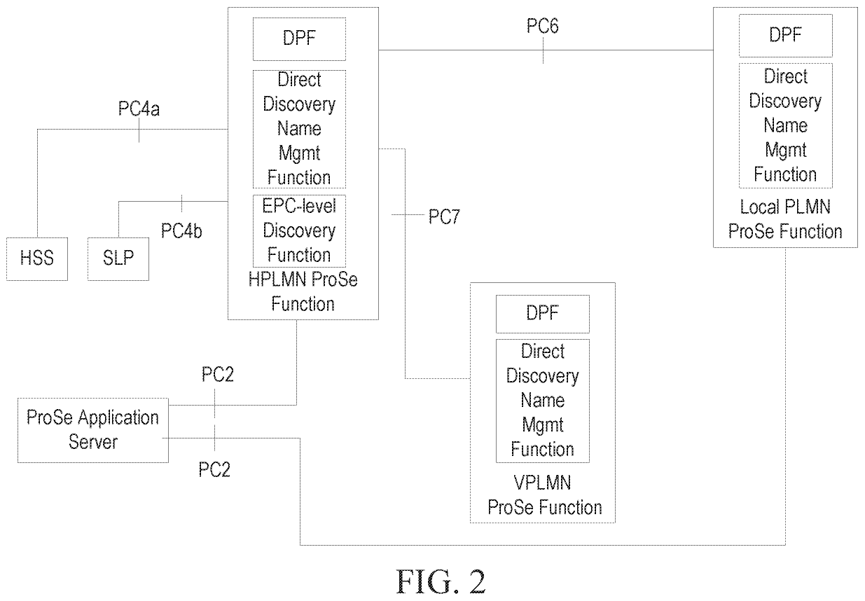

### DETAILED DESCRIPTION

As described above, when the PCF maintains the PDUID, the PCF may keep updating the PDUID according to the timer and provision the new PDUID to the wireless device. However, wireless device may not always want to perform restricted ProSe direct discovery such that the wireless device does not use the updated PDUID, thereby wasting resources, especially if the PCK keeps updating the PDUID and the wireless device continues to not use the updated PDUID. It may be helpful and consume less resources if the PCF stops updating the PDUID if the wireless device is not interested in performing restricted ProSe direct discovery any longer.

Before describing in detail exemplary embodiments, it is noted that the embodiments reside primarily in combinations of apparatus components and processing steps related to ProSe direct discovery control. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises.” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

In some embodiment, core network node may correspond and/or include one or more logical nodes in the core network such as AMF logical node (referred to as AMF), PCF logical node (referred to as PCF), etc., where communication between logical nodes may occur over one or more interfaces.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

An indication generally may explicitly and/or implicitly indicate the information it represents. Implicit indication may for example be based on position and/or resource used for transmission. Explicit indication may for example be based on a parametrization with one or more parameters, and/or one or more index or indices, and/or one or more bit patterns representing the information and/or specific type of message.

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

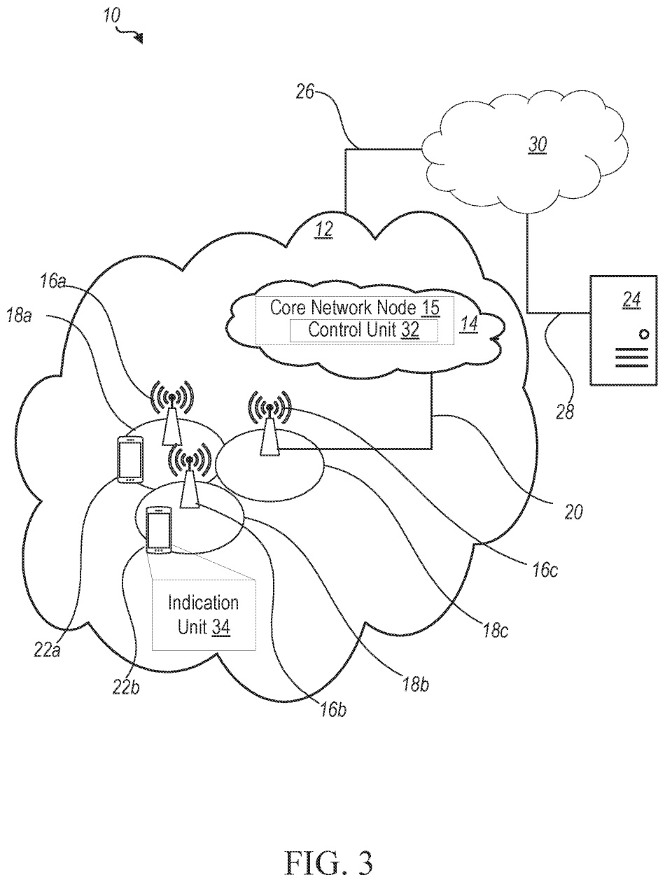

Some embodiments provide ProSe direct discovery control. Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A core network node 15 includes a control unit 32 which is configured to perform one or more core network node 15 functions as described herein such as with respect to ProSe direct discovery control. A wireless device 22 includes an indication unit 34 which is configured to perform one or more wireless devices 22 functions as described herein such as with respect to ProSe direct discovery control.

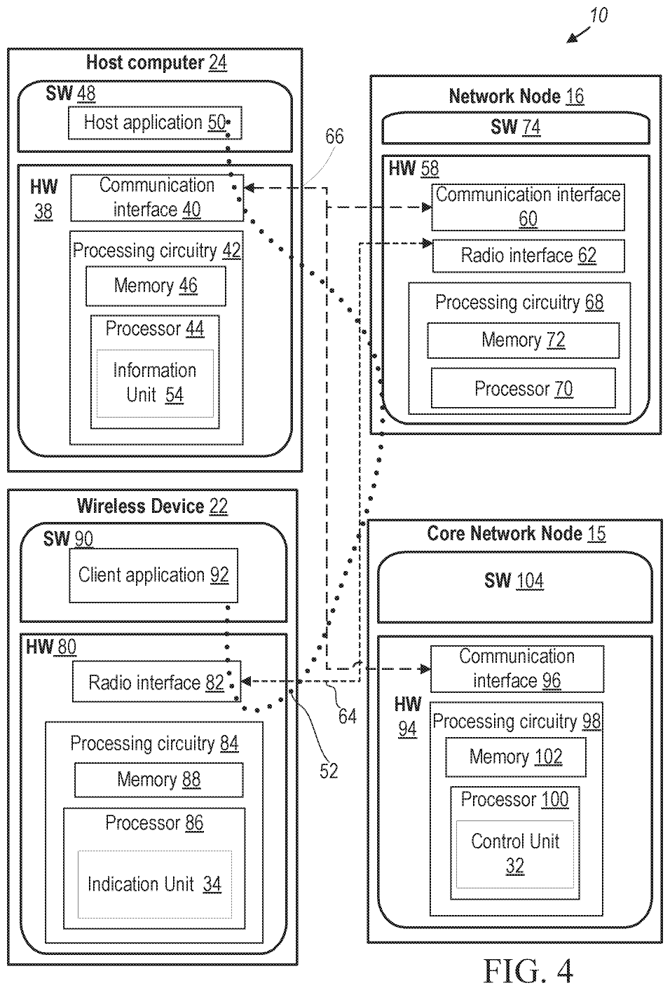

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to perform one or more host computer functions 24 such as storing, analysis, determining, updating, relaying, forwarding, transmitting, receiving, etc. information associated with ProSe direct discovery control.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an indication unit 34 configured to perform one or more wireless device 22 functions as described herein such as with respect to ProSe direct discovery control.

The communication system 10 further includes a core network node 15 provided in a communication system 10 and including hardware 94 enabling it to communicate with network node 16, the WD 22 (e.g., via network node 16) and other entities in system 10 and core network 14. The hardware 94 may include a communication interface 96 for setting up and maintaining a connection with an interface of a different entity in core network 14 and/or with network node 16. The communication interface 60 may be configured to facilitate a connection 66 to the host computer 24.

In the embodiment shown, the hardware 94 of the core network node 15 further includes processing circuitry 98. The processing circuitry 98 may include a processor 100 and a memory 102. In particular, in addition to or instead of a processor, such as a central processing unit, and memory, the processing circuitry 98 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 100 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the core network node 15 further has software 104 stored internally in, for example, memory 102, or stored in external memory (e.g., database, storage array, network storage device, etc.) accessible by the core network node 15 via an external connection. The software 104 may be executable by the processing circuitry 98. The processing circuitry 98 may be configured to control any of the methods and/or processes described herein and/or to cause such methods, and/or processes to be performed, e.g., by core network node 15. Processor 100 corresponds to one or more processors 100 for performing core network node 15 functions described herein. The memory 102 is configured to store data, programmatic software code and/or other information described herein. In some embodiments, the software 104 may include instructions that, when executed by the processor 100 and/or processing circuitry 98, causes the processor 100 and/or processing circuitry 98 to perform the processes described herein with respect to core network node 15. For example, processing circuitry 98 of the core network node 15 may include control unit 32 configured to perform one or more core network node 15 functions as described herein such as with respect to ProSe direct discovery control.

In some embodiments, the inner workings of the core network node 15, network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16 and/or core network node 15, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as control unit 32, and indication unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

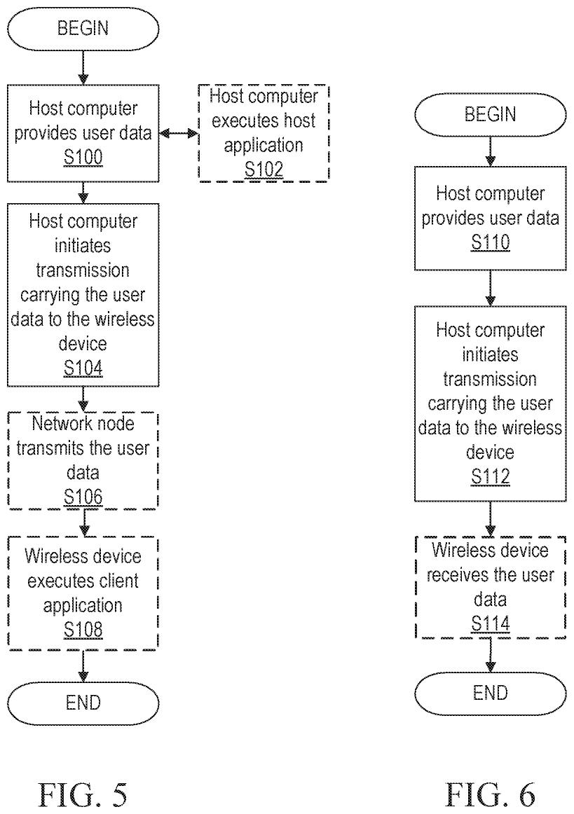

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

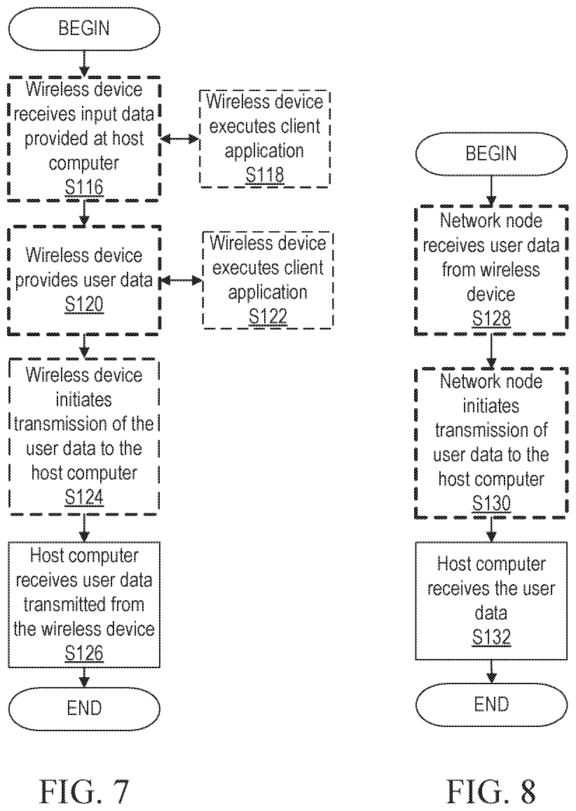

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

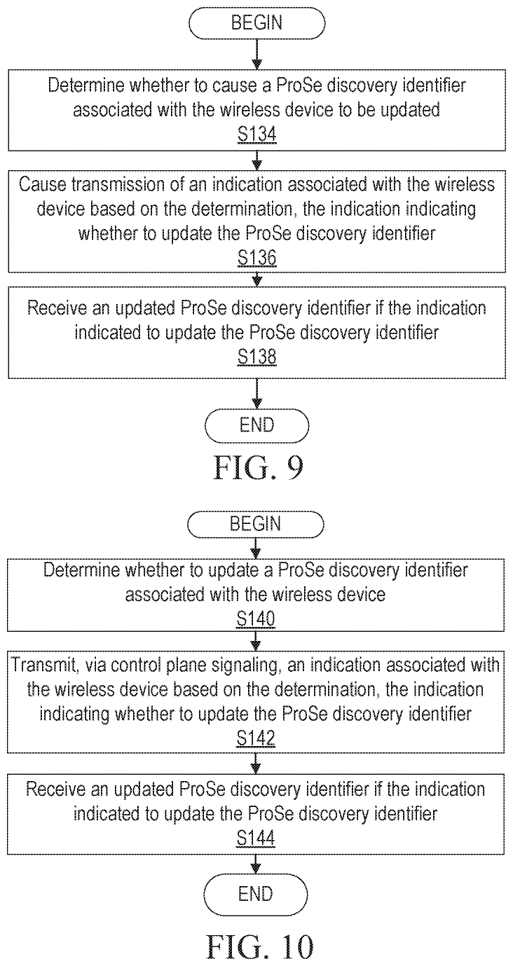

FIG. 9 is a flowchart of an example process in a wireless device 22 according to some embodiments of the present disclosure. One or more blocks described herein may be performed by one or more elements of wireless device 22 such as by one or more of processing circuitry 84 (including the indication unit 34), processor 86, radio interface 82 and/or communication interface 60. Wireless device 22 is configured to determine (Block S134) whether to cause a ProSe discovery identifier associated with the wireless device to be updated, as described herein. Wireless device 22 is configured to cause (Block S136) transmission of an indication associated with the wireless device 22 based on the determination where the indication indicates whether to update the ProSe discovery identifier, as described herein. Wireless device 22 is configured to receive (Block S138) an updated ProSe discovery identifier if the indication indicated to update the ProSe discovery identifier, as described herein.

According to one or more embodiments, the indication is a restricted discovery type indication configured to cause the ProSe discovery identifier to be updated. According to one or more embodiments, the indication is a registration request configured to update a restricted discovery capability of policy control of the wireless device 22 for disabling restricted discovery.

FIG. 10 is a flowchart of another example process in a wireless device 22 according to some embodiments of the present disclosure. One or more blocks described herein may be performed by one or more elements of wireless device 22 such as by one or more of processing circuitry 84 (including the indication unit 34), processor 86, radio interface 82 and/or communication interface 60. Wireless device 22 is configured to determine (Block S140) whether to update a ProSe discovery identifier associated with the wireless device 22, as described herein. Wireless device 22 is configured to transmit (Block S142), via control plane signaling, an indication associated with the wireless device 22 based on the determination where the indication indicates whether to update the ProSe discovery identifier, as described herein. Wireless device 22 is configured to receive (Block S144) an updated ProSe discovery identifier if the indication indicated to update the ProSe discovery identifier, as described herein.

According to one or more embodiments, the indication is a discovery type indication configured to cause the ProSe discovery identifier to be updated. According to one or more embodiments, the indication is a registration request requesting to update a restricted discovery capability associated with the wireless device 22 for disabling restricted discovery. According to one or more embodiments, the ProSe discovery identifier is associated with a timer, where the processing circuitry 84 is configured to receive another updated ProSe discovery identifier based on expiration of the timer.

According to one or more embodiments, the determination whether to update a ProSe discovery identifier associated with the wireless device 22 includes determining a current ProSe discovery identifier is invalid. According to one or more embodiments, the indication indicates a change in the ProSe capabilities of the wireless device 22 and indicates not to update the ProSe discovery identifier. According to one or more embodiments, the indication is included in a NAS message indicating not to update the ProSe discovery identifier associated with the wireless device 22.

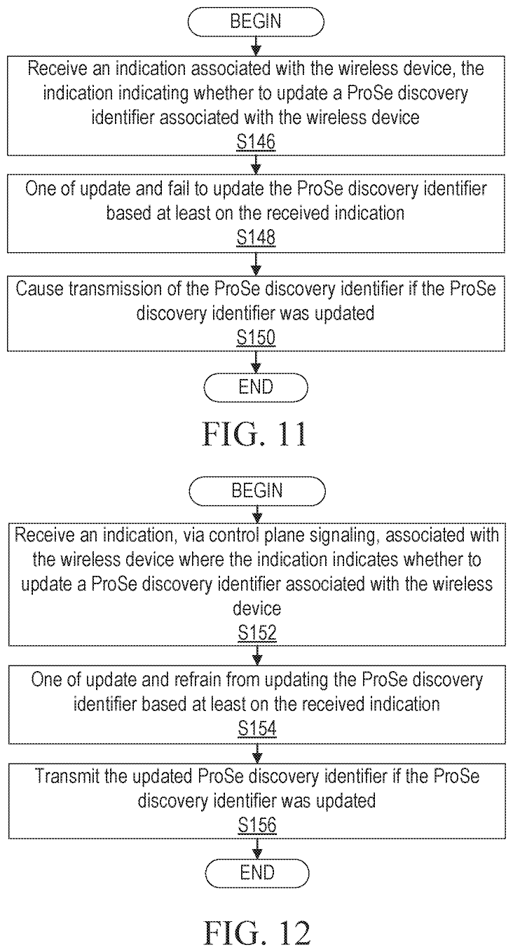

FIG. 11 is a flowchart of an example process in a core network node 15 according to some embodiments of the present disclosure. One or more blocks described herein may be performed by one or more elements of core network node 15 such as by one or more of processing circuitry 98 (including the control unit 32), processor 100, and/or communication interface 96. Core network node 15 is configured to receive (Block S146) an indication associated with the wireless device 22 where the indication indicates whether to update a ProSe discovery identifier associated with the wireless device 22, as described herein. Core network node 15 is configured to one of update and fail to update (Block S148) the ProSe discovery identifier based at least on the received indication, as described herein. Core network node 15 is configured to cause (Block S150) transmission of the ProSe discovery identifier if the ProSe discovery identifier was updated, as described herein.

According to one or more embodiments, the indication is a restricted discovery type indication configured to cause the ProSe discovery identifier to be updated. According to one or more embodiments, the indication is a registration request configured to update a restricted discovery capability of policy control of the wireless device 22 for disabling restricted discovery.

FIG. 12 is a flowchart of another example process in a core network node 15 according to some embodiments of the present disclosure. One or more blocks described herein may be performed by one or more elements of core network node 15 such as by one or more of processing circuitry 98 (including the control unit 32), processor 100, and/or communication interface 96. Core network node 15 is configured to receive (Block S152) an indication, via control plane signaling, associated with the wireless device 22 where the indication indicates whether to update a ProSe discovery identifier associated with the wireless device 22, as described herein. Core network node 15 is configured to one of (Block S154) update and refrain from updating the ProSe discovery identifier based at least on the received indication, as described herein. Core network node 15 is configured to transmit (Block S156) the updated ProSe discovery identifier if the ProSe discovery identifier was updated, as described herein.

According to one or more embodiments, the indication is a discovery type indication configured to cause the ProSe discovery identifier to be updated. According to one or more embodiments, the indication is a registration request requesting to update a restricted discovery capability associated with the wireless device 22 for disabling restricted discovery. According to one or more embodiments, the ProSe discovery identifier is associated with a timer where the processing circuitry 98 is configured to update the ProSe discovery identifier based on expiration of the timer.

According to one or more embodiments, the processing circuitry 98 is configured to update the ProSe discovery identifier based on the ProSe discovery identifier being invalid. According to one or more embodiments, the indication indicates a change in the ProSe capabilities of the wireless device 22 where the refraining from updating the ProSe discovery identifier being based on the change in the ProSe capabilities of the wireless device 22. According to one or more embodiments, the indication is included in a NAS message indicating not to update the ProSe discovery identifier associated with the wireless device 22.

Having generally described arrangements for ProSe direct discovery control, details for these arrangements, functions and processes are provided as follows, and which may be implemented by the core network node 15, wireless device 22 and/or host computer 24.

Some embodiments provide ProSe direct discovery control. One or more core network node 15 functions described below may be performed by one or more of processing circuitry 98, processor 100, control unit, communication interface 96, etc. In one or more embodiments, core network node 15 may provide one or more logical nodes and/or functions such as a PCF, AMF, etc. that are in communication with each other via one or more interfaces. Thus, references herein to PCF and AMF are understood to be, or to be part of, a core network node 15.

One or more wireless device 22 functions described below may be performed by one or more of processing circuitry 84, processor 86, indication unit 34, radio interface 82, etc.

### PCF Keeps Updating PDUID by Default (Option 1)

In one or more embodiments, new indication information is sent by wireless devices 22 to indicate whether wireless device 22 wants to perform restricted ProSe direct discovery. In one example, the indication or indication information is a restricted discovery indication. This indication can be included in wireless device 22 registration request in the following (but not limited to) ways/methods:
The indication can be represented by a new 5GS mobility management (5GMM) capability (e.g., restricted discovery capability), or
The indication can be provided in the wireless device 22 policy container, e.g.,
   a new value for the wireless device 22 policy part type (as defined in 3GPP standards such as in Annex D6.2 3GPP TS 24.501) can be defined for PDUID provisioning or restricted ProSe discovery; or
   a new optional information element (IE), e.g., PDUID or restricted discovery indication, may be provided in the payload container entry (as defined in 3GPP standards such as in clause 9.11.3.39 3GPP TS 24.501)
Or the indication may be included in the registration message in a new field.

When wireless device 22 wants or determines to perform the restricted ProSe direct discovery, wireless device 22 may need the PCF to maintain its PDUID, then the PCF may send the wireless device registration request to the network with the restricted discovery indication. Otherwise, the indication is not included or may be disabled.

In one or more embodiments, a pre-condition may be for wireless device 22 to be authorized to perform restricted ProSe direct discovery where wireless device 22 has a PDUID provided by the PCF. The PDUID may be associated with a timer, when the timer expires or before the timer expires, the PCF may automatically generate a new PDUID for that wireless device 22 and provides the new PDUID to the wireless device 22.

The policy control function (PCF) provisions a new Policy Control Request Trigger (PCRT) to instruct the application management function (AMF) to inform the PCF if wireless device 22 sends the indication using restricted discovery capability. In one or more embodiments, wireless device 22 may include the indication in the wireless device policy container, then the new PCRT may not be needed.

When wireless device 22 does not want to perform the restricted ProSe direct discovery any longer, and wants PCF to stop updating the PDUID, the following process may occur:

1. Wireless device 22 may send a wireless device Registration Request to the AMF. In the request, wireless device 22 indicates the request is used for updating its capabilities or protocol parameters. Wireless device 22 disables the restricted discovery indication or does not provide the indication in the request.

2. When AMF receives the Registration Request, the AMF calls Npcf_UEPolicyControl_Update service of PCF, based on a new PCRT “request notification of Change of restricted discovery capability” from the PCF to the AMF or based on the reception of the wireless device Policy container. The AMF provides the SUPI (e.g., subscription concealed identifier) for wireless device 22 and the information that wireless device 22 changes is its restricted discovery capability or the wireless device policy container.

3. When the PCF receives Npcf_UEPolicyControl_Update service call (e.g., messaging or signaling) from the AMF, the PCF knows that wireless device 22 does not want to perform the restricted discovery any longer, then PCF stops maintaining the PDUID for wireless device 22.

In one or more embodiments, if wireless device 22 wants or determines to perform the restricted ProSe direct discovery again, and wireless device 22 may need to get a new PDUID from the PCF, the following process may occur:

1. Wireless device 22 sends a wireless device Registration Request to AMF. In the request, wireless device 22 indicates the request is used for updating its capabilities or protocol parameters. Wireless device 22 enables the restricted discovery indication or provides the indication in the request.

2. When AMF receives the Registration Request, the AMF calls/initiates Npcf_UEPolicyControl_Update service of PCF, based on a new PCRT “request notification of Change of restricted discovery capability” from the PCF to the AMF or based on the reception of the wireless device Policy container. The AMF provides the SUPI for wireless device 22 and the information that wireless device 22 changes its restricted discovery capability or wireless device policy container.

3. When the PCF receives Npcf_UEPolicyControl_Update service call from AMF, the PCF knows or determines that wireless device 22 wants to perform the restricted discovery again, then PCF starts maintaining the PDUID for wireless device 22. The PCF keeps updating the PDUID when the timer expires.

PCF does not Update PDUID by Default

In this option, the PCF does not update (e.g., refrains from updating) PDUID by default, when wireless device 22 wants to perform the restricted ProSe direct discovery, and wireless device 22 may need to get a new PDUID from the PCF, the following process may occur:

1. Wireless device 22 sends a wireless device Registration Request to the AMF. In the request, wireless device 22 indicates the request is used for updating its capabilities or protocol parameters. Wireless device 22 provides the wireless device Policy container including its list of PSIs (Policy Section Identifier, for example, as defined in 3GPP standards such as in clause 6.1.2.2.2 in 3GPP TS 23.503) of PDUID in the message. In one or more embodiments, it may be required that the PCF assign a separate PSI to the PDUID.

Alternatively, wireless device 22 can provide the restricted discovery indication in the wireless device policy container as in option 1.

2. When the AMF receives the Registration Request, the AMF finds the PSI or the wireless device policy container, then the AMF knows that the wireless device 22 wants to update some parameters from the PCF. Then the AMF calls the Npcf_UEPolicyControl_Update service of PCF. The AMF provides SUPI of the wireless device 22 and the PSI or the wireless device policy container.

3. When the PCF receives Npcf_UEPolicyControl_Update service call from AMF, the PCF gets the PSI of the PDUID or the indication in the wireless device policy container, then PCF generates a PDUID and the associated timer, and provides them to wireless device 22.

### Examples

Example A1. A core network node 15 configured to communicate with a wireless device 22 (WD 22), the core network node 15 configured to, and/or comprising a radio interface and/or comprising processing circuitry 98 configured to: receive an indication associated with the wireless device 22, the indication indicating whether to update a ProSe discovery identifier associated with the wireless device 22;
one of update and fail to update the ProSe discovery identifier based at least on the received indication; and
cause transmission of the ProSe discovery identifier if the ProSe discovery identifier was updated.

Example A2. The core network node 15 of Example A1, wherein the indication is a restricted discovery type indication configured to cause the ProSe discovery identifier to be updated.

Example A3. The core network node 15 of Example A1, wherein the indication is a registration request configured to update a restricted discovery capability of policy control of the wireless device 22 for disabling restricted discovery.

Example B1. A method implemented in a core network node 15, the method comprising:
receiving an indication associated with the wireless device 22, the indication indicating whether to update a ProSe discovery identifier associated with the wireless device 22;
one of updating and failing to update the ProSe discovery identifier based at least on the received indication; and
causing transmission of the ProSe discovery identifier if the ProSe discovery identifier was updated.

Example B2. The method of Example B1, wherein the indication is a restricted discovery type indication configured to cause the ProSe discovery identifier to be updated.

Example B3. The method of Example B1, wherein the indication is a registration request configured to update a restricted discovery capability of policy control of the wireless device 22 for disabling restricted discovery.

Example C1. A wireless device 22 (WD 22) configured to communicate with a network node 16, the WD 22 configured to, and/or comprising a radio interface 82 and/or processing circuitry 84 configured to:
determine whether to cause a ProSe discovery identifier associated with the wireless device 22 to be updated;
cause transmission of an indication associated with the wireless device 22 based on the determination, the indication indicating whether to update the ProSe discovery identifier; and
receive an updated ProSe discovery identifier if the indication indicated to update the ProSe discovery identifier.

Example C2. The WD 22 of Example C1, wherein the indication is a restricted discovery type indication configured to cause the ProSe discovery identifier to be updated.

Example C3. The WD 22 of Example C1, wherein the indication is a registration request configured to update a restricted discovery capability of policy control of the wireless device 22 for disabling restricted discovery.

Example D1. A method implemented in a wireless device 22 (WD 22), the method comprising:
determining whether to cause a ProSe discovery identifier associated with the wireless device 22 to be updated;
causing transmission of an indication associated with the wireless device 22 based on the determination, the indication indicating whether to update the ProSe discovery identifier; and
receiving an updated ProSe discovery identifier if the indication indicated to update the ProSe discovery identifier.

Example D2. The method of Example D1, wherein the indication is a restricted discovery type indication configured to cause the ProSe discovery identifier to be updated.

Example D3. The method of Example D1, wherein the indication is a registration request configured to update a restricted discovery capability of policy control of the wireless device 22 for disabling restricted discovery.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AMF Access and Mobility Management Function
CN Core Network
DNN Data Network Name
GPSI Generic Public Subscription Identifier
NEF Network Exposure Function
PCF Policy Control Function
PDU Protocol Data Unit
S-NSSAI Single Network Slice Selection Assistance Information
SSC Session and Service Continuity
SUPI Subscription Permanent Identifier
UDM Unified Data Management
UDR Unified Data Repository

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A core network node comprising:
processing circuitry configured to:
receive an indication, via control plane signaling, associated with a wireless device, the indication indicating whether to update a ProSe discovery identifier associated with the wireless device;
one of update and refrain from updating the ProSe discovery identifier based at least on the received indication; and
transmit the updated ProSe discovery identifier if the ProSe discovery identifier was updated.

2. The core network node of claim 1, wherein the indication is a discovery type indication configured to cause the ProSe discovery identifier to be updated.

3. The core network node of claim 1, wherein the indication is a registration request requesting to update a restricted discovery capability associated with the wireless device for disabling restricted discovery.

4. The core network node of claim 1, wherein the ProSe discovery identifier is associated with a timer; and
the processing circuitry being configured to update the ProSe discovery identifier based on expiration of the timer.

5. The core network node of claim 1, wherein the processing circuitry is configured to update the ProSe discovery identifier based on the ProSe discovery identifier being invalid.

6. The core network node of claim 1, wherein the indication indicates a change in ProSe capabilities of the wireless device; and
the refraining from updating the ProSe discovery identifier being based on the change in the ProSe capabilities of the wireless device.

7. The core network node of claim 1, wherein the indication is included in a NAS message indicating not to update the ProSe discovery identifier associated with the wireless device.

8. A method implemented by a core network node, the method comprising:
receive an indication, via control plane signaling, associated with a wireless device, the indication indicating whether to update a ProSe discovery identifier associated with the wireless device;
one of update and refrain from updating the ProSe discovery identifier based at least on the received indication; and
transmit the updated ProSe discovery identifier if the ProSe discovery identifier was updated.

9. The method of claim 8, wherein the indication is a discovery type indication configured to cause the ProSe discovery identifier to be updated.

10. The method of claim 8, wherein the indication is a registration request requesting to update a restricted discovery capability associated with the wireless device for disabling restricted discovery.

11. The method of claim 8, wherein the ProSe discovery identifier is associated with a timer; and
the method further comprising updating the ProSe discovery identifier based on expiration of the timer.

12. The method of claim 8, further comprising updating the ProSe discovery identifier based on the ProSe discovery identifier being invalid.

13. The method of claim 8, wherein one or both:
the indication indicates a change in ProSe capabilities of the wireless device; and
the refraining from updating the ProSe discovery identifier being based on the change in the ProSe capabilities of the wireless device; and
the indication is included in a NAS message indicating not to update the ProSe discovery identifier associated with the wireless device.

14. (canceled)

15. A wireless device comprising:
processing circuitry configured to:
determine whether to update a ProSe discovery identifier associated with the wireless device;
transmit, via control plane signaling, an indication associated with the wireless device based on the determination, the indication indicating whether to update the ProSe discovery identifier; and
receive an updated ProSe discovery identifier if the indication indicated to update the ProSe discovery identifier.

16. The wireless device of claim 15, wherein the indication is a discovery type indication configured to cause the ProSe discovery identifier to be updated.

17. The wireless device of claim 15, wherein the indication is a registration request requesting to update a restricted discovery capability associated with the wireless device for disabling restricted discovery.

18. The wireless device of claim 15, wherein the ProSe discovery identifier is associated with a timer; and
the processing circuitry being configured to receive another updated ProSe discovery identifier based on expiration of the timer.

19. The wireless device of claim 15, wherein the determination whether to update a ProSe discovery identifier associated with the wireless device includes determining a current ProSe discovery identifier is invalid.

20. The wireless device of claim 15, wherein the indication indicates a change in ProSe capabilities of the wireless device and indicates not to update the ProSe discovery identifier.

21. The wireless device of claim 15, wherein the indication is included in a NAS message indicating not to update the ProSe discovery identifier associated with the wireless device.

22. A method implemented by a wireless device, the method comprising:
determining whether to update a ProSe discovery identifier associated with the wireless device;
transmitting, via control plane signaling, an indication associated with the wireless device based on the determination, the indication indicating whether to update the ProSe discovery identifier; and
receiving an updated ProSe discovery identifier if the indication indicated to update the ProSe discovery identifier.

23. The method of claim 22, wherein the indication is a discovery type indication configured to cause the ProSe discovery identifier to be updated.

24. The method of claim 22, wherein the indication is a registration request requesting to update a restricted discovery capability associated with the wireless device for disabling restricted discovery.

25. The method of claim 22, wherein the ProSe discovery identifier is associated with a timer; and
the method further comprising receiving another updated ProSe discovery identifier based on expiration of the timer.

26. The method of claim 22, wherein the determination whether to update a ProSe discovery identifier associated with the wireless device includes determining a current ProSe discovery identifier is invalid.

27. The method of claim 22, wherein one or both:
the indication indicates a change in ProSe capabilities of the wireless device and indicates not to update the ProSe discovery identifier, and
the indication is included in a NAS message indicating not to update the ProSe discovery identifier associated with the wireless device.

28. (canceled)
